(19) United States
(12) Patent Application Publication
(10) Pub. No.: US 2024/0313989 A1
(43) Pub. Date: Sep. 19, 2024

(54) METHOD FOR MANAGING THE POWER CONSUMPTION OF EQUIPMENT IN A LOCAL COMMUNICATIONS NETWORK, CORRESPONDING MANAGEMENT DEVICE AND COMPUTER PROGRAM

(71) Applicant: Orange, Issy-Les-Moulineaux (FR)

(72) Inventors: Philippe DUSSAUME, Chatillon Cedex (FR); Jean-Philippe JAVAUDIN, Chatillon Cedex (FR); Gregory ROGER, Chatillon Cedex (FR)

(21) Appl. No.: 18/577,015

(22) PCT Filed: Jul. 4, 2022
(86) PCT No.: PCT/FR2022/051330

§ 371 Date: Jan. 5, 2024

(30) Foreign Application Priority Data
Jul. 7, 2021 (FR) FR2107342

(51) Int. Cl. H04L 12/12; H04L 12/28; H04L 12/66

(52) U.S. Cl. CPC H04L 12/12; H04L 12/2834; H04L 12/66

(57) ABSTRACT

A method of managing the power consumption of a local communications network to which at least one piece of user equipment is connected, the local communications network being managed by a gateway for access to a remote communications network. The method is implemented by the gateway and includes: obtaining at least one piece of information relating to at least one power supply source of the local communications network; obtaining at least one piece of information relating to a power consumption level of the at least one piece of equipment, and commanding the power consumption level of the at least one piece of equipment and/or the at least one power supply source to be modified on the basis of the information obtained.

### CROSS-REFERENCE TO RELATED APPLICATIONS

This application is filed under 35 U.S.C. § 371 as the U.S. National Phase of Application No. PCT/FR2022/051330 entitled “METHOD FOR MANAGING THE POWER CONSUMPTION OF EQUIPMENT IN A LOCAL COMMUNICATIONS NETWORK, CORRESPONDING MANAGEMENT DEVICE AND COMPUTER PROGRAM” and filed Jul. 4, 2022, and which claims priority to FR 2107342 filed Jul. 7, 2021, each of which is incorporated by reference in its entirety.

### BACKGROUND

### Field

The field of the development is that of a local home or professional communications network, managed by a gateway, known as a home or professional gateway, to which user equipment is connected.

In particular, the development relates to the overall management of the power consumption of the local communications network, and in particular of its equipment, according to information relating to electrical power supply sources such as those of one or more electricity suppliers or those produced locally at the home or business, and of the current and/or forecast level of consumption of the user equipment of the local communications network, of which the gateway is also a part.

Managing the power consumption of the local communications network means managing several parameters such as: the level of consumption, that is the quantity, or power level, of energy consumed overall by the network equipment or individually by each piece of equipment and; the origin (or source) of the power supply to the network equipment.

### Prior Art and its Disadvantages

In the connected home, the quest to control the cost of electrical energy requires information on local energy resources (solar panels, wind turbines, back-up batteries, etc.) or remote energy resources (electrical network of an energy supplier) available over time, on the needs of user equipment within the home, and on any fluctuating energy prices under certain power supply contracts.

For electricity suppliers, or electric grid operators, this involves being able to provide flexible services, adapted not only to their customers' demand, but also to their own resources and the prices on the electricity grid interconnection market, taking into account any prioritisation between their customers.

Cost control and access to a flexible power supply service therefore depend on customers being informed by their energy supplier(s) about the forecast and real-time evolution of the power supply service to which they have subscribed.

To generate this kind of information on changes in the power supply service, particularly in terms of the availability of electrical energy of a network or price, mediation with the information systems, or IS, of the electricity grid operators is necessary.

Conventionally, this mediation could be provided by a connection between such information systems and a smart electricity meter in the connected home, but it no longer works when the electricity supply is cut off, for example because of a fault in the electricity grid.

There is therefore a need for a technique for managing the power consumption of a local communications network that does not have this drawback. In particular, there is a need for such a technique that can both adapt the power consumption as such of communications network equipment and modify the power supply sources made available to the equipment to anticipate and control changes in electrical power resource, and to manage mains failure situations.

### SUMMARY

The development responds to this need by proposing a method of managing the power consumption of a local communications network (LAN) to which at least one piece of user equipment is connected, this local communications network (LAN) being managed by a gateway for access to a remote communications network. The method is implemented by the gateway and comprises: obtaining at least one piece of information relating to at least one power supply source for the local communications network (LAN); obtaining at least one piece of information relating to a power consumption level of said at least one piece of equipment, a command for modifying the power consumption level of said at least one piece of equipment and/or said at least one power supply source according to the information obtained.

Thus, the development is based on a completely new and inventive approach to managing power consumption, i.e. managing the level of consumption and the origin, or source, of the power supply (energy supplied by an electricity supplier or locally to the network by a back-up battery, or local energy production) of the local communications network managed by a home or professional gateway. In other words, the development proposes to take advantage of the fact that the gateway has access to the equipment of the local home or professional communications network and can therefore: adapt the power consumption level of this equipment, that is modify the level of power consumed by this equipment, and/or modify the power supply source or sources for this equipment (supply source external to the communications network provided by an electricity supplier or source internal to, or local to, the communications network).

In particular, the gateway takes into account, on the one hand, information relating to at least one power supply source, whether located outside the LAN (external source) or within the local network (internal source), and on the other hand, a piece of information about a power consumption level of the equipment of the LAN to modify the level of electrical consumption automatically by this equipment (electrical power consumed by the equipment) and/or modify the power supply source of this equipment (for example level of energy load to be taken from the mains supply or from local alternative energy sources, choice of energy supplier, etc.).

Centralising the management of the electrical power consumption of equipment of the LAN by the gateway therefore enables the user to optimise their power consumption by acting directly: either on the level of energy consumed by the local communications network equipment, or on the origin of the energy source supplying this equipment (external source from an electricity supplier or internal energy source supplied by local energy production such as a back-up battery or solar panels). In this way, users can control the cost of their electricity consumption and avoid unpleasant surprises on their electricity bill.

More specifically, the modification command depends on a priority level and/or an individual power consumption level of said at least one piece of equipment, as a decision criterion.

The gateway is configured to obtain this decision criterion on a priority level and/or a power consumption level for each of the pieces of equipment in the local communications network.

In a particular characteristic, the modification command depends on at least one cost threshold associated with an energy power level provided by at least one power supply source external to the local communications network (LAN), as a further decision criterion.

Advantageously, the gateway is configured to obtain information about an acceptable cost threshold for a user.

These decision criteria have, for example, been set by the local network user.

For example, these decision criteria are obtained from an internal schedule of the electricity consumption of the network equipment, a schedule of usage situations (priority level criterion) and a schedule for choosing energy suppliers (acceptable cost threshold). It is thus possible to choose suppliers and therefore energy prices based on current or forecast power consumption levels, locally available private energy sources (presumed to be free) and a maximum acceptable energy cost level, for example defined by the user.

In one example, the gateway calculates any periods of time when the maximum acceptable cost is likely to be exceeded for the home or professional installation of the user, and accordingly modifies the supply source and/or adapts the power consumption of the installation to ensure that the cost of power consumption remains below this threshold.

Advantageously, the home or professional gateway evaluates in real time the foreseeable adequacy in the time between, on the one hand, the availability of the external and/or internal power supply source, or even its cost (when it is an external source supplied by an electricity supplier) and, on the other hand, the estimated level of consumption of the home or professional communications network equipment. Hence, it is possible to direct the management of the operation of the installation, including its internal hardware and/or software resources, as well as, if necessary, the temporary choice of a new supplier from among several possible ones.

According to another characteristic of the development, the command for modifying the power consumption level of said at least one piece of equipment is selected from: a command for shutting down said at least one piece of equipment according to the priority level and/or the individual consumption level of said at least one piece of equipment; a command for putting said at least one piece of equipment on standby according to the priority level and/or the individual consumption level of said at least one piece of equipment a command for reactivating said at least one piece of equipment.

Advantageously, the gateway can modify, or adapt, the power consumption level of the equipment of the LAN. More specifically, the gateway can control the shutdown or standby mode of certain items of network equipment, or certain hardware or software interfaces of this equipment. To do this, it takes into account not only information relating to a power supply source, in particular from electricity suppliers or local energy production, but also information on the level of consumption of the communications network equipment.

The transmission of commands to shut down certain equipment temporarily, to put them on standby, totally or partially, or to reactivate them, can be done either by sending ad hoc application messages directly to the communications network equipment or to programmed plugs that supply certain equipment.

Advantageously, the command to shut down or put on standby a piece of equipment depends on its level of priority and/or its level of individual power consumption, i.e. its importance within the communications network and/or its own power consumption level. For example, in order to reduce the overall consumption of equipment in the communications network, equipment with a high priority remains switched on, whereas equipment with a low priority is shut down or put on standby if it must continue receiving information from the gateway, for example. In another example, equipment that consumes a lot of electrical energy is shut down, while equipment that consumes little electrical energy remains in service. In another example, if a piece of equipment consumes a lot of energy, but has a high priority, then it stays on or is put on standby to continue receiving messages from the gateway.

Conversely, the gateway can transmit a command to reactivate or restart a piece of equipment when the overall consumption level of the network or installation has fallen back below the acceptable threshold, or when power is restored to the installation.

According to a particular aspect of the development, the control for modifying said at least one power supply source is selected from: a command for putting into service another power supply source; a command for planned outage of said at least one power supply source.

Advantageously, the gateway can modify the power supply source, i.e. it can modify the source of the electricity that is going to supply the local communications network equipment. More specifically, the gateway can control the use of alternative power sources to the energy of the electrical grid, such as local private alternative energy production sources (solar panels, wind turbines, etc.) or back-up energy sources internal to the communications network (equipment back-up batteries, inverters, etc.), or even a change of energy supplier. For example, it is possible to change the power supply source by terminating an electricity supply contract with one supplier and taking out a contract with another supplier. In another example, it is possible to put into service sources of power supply internal to the communications network, such as back-up batteries, or to use internal sources of energy production, such as solar panels, to supply the communications network equipment and thus reduce the amount of electricity drawn from the mains.

According to another particular aspect of the development, the at least one piece of information relating to said at least one power supply source belongs to a group comprising: a piece of information relating to the energy power level supplied by said at least one power supply source, a piece of information relating to a time limit for the availability of the energy power level supplied by said at least one power supply source; a piece of information relating to a cost associated with the energy power level supplied by said at least one external power supply source; a piece of information relating to a supply incident involving said external energy source.

Advantageously, the gateway has one or more pieces of information about: the energy availability, i.e. the current or forecast distributed power for a set of energy suppliers or for internal power supply sources (back-up batteries, local energy production, etc.), current and/or forecast energy prices for a set of electricity suppliers and events such as incidents on the network, for example power failures.

In this way, the gateway can adapt the power consumption level of the equipment of the LAN, and/or modify the origin of this energy to be able to anticipate consumption and the associated costs as effectively as possible.

Advantageously, the gateway is also configured to receive information about power supply incidents linked, for example, to weather conditions in one or more geographical areas. In this way, it is possible to anticipate stresses on the electrical network linked, for example, to the use of heating or air-conditioning systems, or to anticipate the recharging of local alternative energy resources (e.g. back-up batteries) in the event of a storm, for example, and therefore a potential power failure.

According to another particular aspect of the development, the at least one piece of information relating to said at least one power supply source is obtained from a message received from an information platform relating to a power supply via the remote communications network.

In this way, the gateway is configured to receive information relating to a power supply source from the information systems of one or more energy suppliers. Advantageously, the gateway receives this information from a single energy information platform which itself collects this information from energy suppliers. This information relating to an external power supply source corresponds in particular to information on the status of the electrical network (availability of electrical load, network overvoltage, mains failure, etc.) or on power consumption conditions (such as current or forecast energy prices charged by one or more suppliers, contractual conditions of the suppliers, etc.). This energy information platform makes it possible to concatenate information from the information systems of electricity suppliers and in particular to provide a link between the information systems (or IS) of energy suppliers and the gateway and to offer a service to the user of the communications network.

According to another particular aspect of the development, the at least one piece of information relating to said at least one power supply source is obtained from a message received from a piece of equipment of the local communications network (LAN) comprising an internal power supply source configured to power said at least one piece of equipment of the local communications network (LAN).

Advantageously, in the event of a power failure or power restoration, the home or professional gateway can manage the electricity consumption of the local communications network in real time and continuously. Some network equipment, such as an inverter, comprise power supply sources (e.g. back-up battery) that are configured to supply energy to other equipment of the communications network in the event of a power failure, taking over from the faulty energy supplier. They inform the gateway of the status of the electrical network, and continue to send messages to the gateway about the charge level and capacity of their battery and the remaining autonomy, depending on the consumption of other equipment.

The development also relates to a device for managing the power consumption of a local communications network (LAN) to which at least one piece of equipment is connected, this local communications network (LAN) being managed by a gateway for access to a remote communications network. The management device comprises: a module for obtaining at least one piece of information relating to at least one power supply source for the local communications network (LAN); a module for obtaining at least one piece of information relating to a power consumption level of said at least one piece of equipment, a command module for modifying the power consumption level of said at least one piece of equipment and/or said at least one power supply source according to said information obtained.

According to a particular characteristic of the development, the command module is configured to take into account at least one decision criterion belonging to the group comprising: a cost threshold associated with an energy power level supplied by said at least one power supply source external to said local communications network (LAN); a priority level and/or an individual power consumption level of said at least one piece of equipment.

According to a particular aspect of the development, the command module is further configured to transmit a command for modifying the power consumption level of said at least one piece of equipment selected from: a command for shutting down said at least one piece of equipment according to said priority level and/or said individual consumption level of said at least one piece of equipment; a command for putting said at least one piece of equipment on standby according to said priority level and/or said individual consumption level of said at least one piece of equipment; a command for reactivating said at least one piece of equipment.

According to another particular aspect of the development, said command module is further configured to transmit a command for modifying said at least one power supply source selected from: a command for putting into service another power supply source; a command for planned outage of said power supply source.

The development also relates to a gateway of a local communications network (LAN) configured to manage the local communications network (LAN) to which at least one piece of equipment is connected. The gateway comprises a device for managing power consumption as described above.

The development also relates to a system for managing the power consumption of a local communications network (LAN) to which at least one piece of equipment is connected, this local communications network (LAN) being managed by a gateway for access to a remote communications network. The system comprises a gateway as previously described and a power supply information platform connected to at least one information system of an energy supplier and configured to transmit to the gateway a message comprising at least one piece of information relating to at least one power supply source external to said local communications network (LAN).

According to a particular aspect of the development, the management system further comprises at least one pieces of equipment of the local communications network (LAN) comprising an internal power supply source configured to power the at least one piece of equipment of the local communications network (LAN).

The development also relates to a computer program product comprising program code instructions for implementing a method for managing a power consumption of a local communications network (LAN) as described previously, when it is executed by a processor.

A program can use any programming language, and can be in the form of source code, object code, or intermediate code between source code and object code, such as in a partially compiled form, or in any other desirable form.

The development also relates to a computer-readable storage medium on which is saved a computer program comprising program code instructions for implementing the steps of the method according to the development as described above.

Such a storage medium can be any entity or device able to store the program. For example, the medium can comprise a storage means, such as a ROM, for example a CD-ROM or a microelectronic circuit ROM, or a magnetic recording means, for example a mobile medium (memory card) or a hard disk or SSD.

On the other hand, such a storage medium can be a transmissible medium such as an electrical or optical signal, that can be carried via an electrical or optical cable, by radio or by other means, so that the computer program contained therein can be executed remotely. The program according to the development can be downloaded in particular on a network, for example the Internet network.

Alternatively, the storage medium can be an integrated circuit in which the program is embedded, the circuit being adapted to execute or to be used in the execution of the above-mentioned display control method.

According to an embodiment, the present technique is implemented using software and/or hardware components. In this context, the term “module” may be used in this document to refer to a software component, a hardware component or a combination of hardware and software components.

A software component is one or more computer programs, one or more subroutines of a program, or more generally any element of a program or software capable of implementing a function or set of functions, as described below for the module concerned. Such a software component is executed by a data processor of a physical entity (terminal, server, gateway, set-top-box, router, etc.) and is able to access the hardware resources of this physical entity (memories, recording media, communication buses, electronic input/output cards, user interfaces, etc.). Hereafter, resources are understood to be any set of hardware and/or software elements that support a function or a service, whether individually or in combination.

In the same way, a hardware component is any element of a hardware assembly capable of implementing a function or set of functions, as described below for the module concerned. It may be a programmable hardware component or a component with an embedded processor for executing software, for example, an integrated circuit, a smart card, a memory card, an electronic card for executing firmware, etc.

The various embodiments mentioned above can be combined with each other for the implementation of the present technique.

The above-mentioned corresponding device, the gateway, the computer program, and the system have at least the same advantages as those provided by the power consumption management method according to the present development.

### BRIEF DESCRIPTION OF THE DRAWINGS

Other purposes, features and advantages of the development will become more apparent upon reading the following description, hereby given to serve as an illustrative and non-restrictive example, in relation to the figures, among which:

FIG. 1 shows an example of an implementation environment of the development according to a particular embodiment;

FIG. 2 shows an example of an implementation environment of the development according to another particular embodiment;

FIG. 3 shows in the form of a flow diagram an example of the exchanges between an information system of an energy supplier, an energy information platform and a user during a process of subscribing to the energy information service of the energy information platform and validating the information concerning the user according to a particular embodiment;

FIG. 4 illustrates in the form of a flow diagram exchanges between an information system of an energy supplier and a system for managing power consumption during a sequencing of actions for managing the power supply of a local communications network according to a particular embodiment;

FIG. 5 illustrates in the form of a flow diagram exchanges between an energy information platform and a gateway for managing a local communications network during the sequencing of actions for managing the power consumption of a local communications network according to another particular embodiment;

FIG. 6A graphically illustrates an example of changes over time in the pricing levels of two energy suppliers;

FIG. 6B graphically illustrates an example of the costs compared between suppliers, with the power consumption of a home or professional installation changing over time, with evidence of excess consumption by exceeding the maximum desired cost;

FIG. 6C illustrates diagrammatically an example of the costs compared between suppliers, with the power consumption of a home or professional installation changing over time, with evidence of excess consumption by exceeding the maximum desired cost;

FIG. 7 illustrates in the form of a flow diagram exchanges between an information system of an energy supplier and a management gateway of a local communications network during a selection or deselection process by the gateway of an energy supplier for a period of time, according to a particular embodiment;

FIG. 8 illustrates in the form of a flow diagram the exchanges between an information system of an energy supplier and a power supply management system of a home or professional installation, during a selection or deselection process by the gateway, via an energy information platform, of an energy supplier for a period of time, according to a particular embodiment;

FIG. 9 illustrates diagrammatically an example of the architecture of a device for managing energy resources according to a particular embodiment.

### DETAILED DESCRIPTION OF CERTAIN ILLUSTRATIVE EMBODIMENTS

The general principle of the development is based on the management by a gateway of access to a remote communications network, configured to manage a local communications network, of the power consumption of the equipment in this communications network, and more generally of a home or professional installation comprising such equipment, of which the gateway is also a part, but also other equipment, for example of the household electrical appliance type or alternative energy production equipment internal to the home or business.

This management is based on the centralisation by the gateway (home or professional) of information relating to one or more power supply sources and information relating to a power consumption level by the home or professional installation, and on the use of this information to:
modify or adapt the power consumption level of equipment, i.e. the amount of energy (or power) consumed by this equipment (for example, a computer consumes an average of 70-80 W, a home gateway consumes an average of between 8 and 11 W) and/or
change the power supply source, that is change the source of the electrical energy (for example, the energy may be supplied by a first electricity supplier or a second electricity supplier, or it may come from local production in the home, such as solar panels or previously charged back-up batteries).
To be able to decide which modification commands to send, the gateway takes into account decision criteria such as a maximum energy cost threshold acceptable to the user or a priority and/or equipment consumption level.

In one example, in order to guide the management of the operation of Local Communications Network (or Local Area Network, LAN) equipment, including its internal hardware and software components, or the temporary choice of a new energy supplier from a number of possible suppliers, the gateway takes account of: information relating to a power supply source, such as: i) identification of the current energy supplier, the user's current contract with this energy supplier (e.g. pricing, energy load consumed, power consumption conditions, etc.), ii) current and forecast status of the power supply source, i.e. status of a supplier's electricity network or status of local energy production sources (e.g. level of electrical power available on the network or charge level and capacity of a back-up battery, timeframe for availability of the level of electrical power or autonomy of a back-up battery, prices according to possible suppliers, etc.); information relating to the power consumption level of the communications network equipment, such as: i) current and cumulative total or individual electrical power consumption of the equipment, ii) current and forecast energy requirements for equipment, depending on current and/or forecast situations or use cases; a decision criterion relating to a threshold for the maximum acceptable cost of energy supplied by suppliers; a decision criterion relating to a level of priority and/or equipment consumption.

In one variant, the cost and power of the energy supplied are two criteria that can be taken into account by the gateway. It can thus be envisioned that the gateway could receive, for example:
information on price changes at constant supply (kVA),
information on changes in supply at a constant unit or fixed price,
information on price and supply trends.

### Description of the Home or Professional Network.

In the remainder of this description, it is considered that a conventional local communications network, or LAN (local area network), is a home network or a professional network, to which a number of pieces of user equipment are connected, as widespread as these, for example:
a home or professional gateway connected to the remote network, or WAN (Wide Area Network), by ADSL (Asymmetric Digital Subscriber Line) copper link or similar, by fibre, and/or by a 3G/4G/5G mobile access, enabling local network equipment to access the remote network and communicate with each other,
an optical termination box, if the gateway has fibre access to the remote WAN network,
Wi-Fi extenders and repeaters, PLC (Power Line Communication) couplers (e.g. Homeplug or G.hn), and Li-Fi lamps,
DECT (Digital Enhanced Cordless Telecommunications) cordless phones, connected via the gateway,
TV set-top boxes (STBs) and television sets,
laptops, tablets and smartphones,
a home automation base, an alarm control unit,
connected objects such as:
   videophone, cameras, sensors (e.g. temperature, opening, water level, etc.),
   actuators (door release, loudspeaker, etc.),
   connected plugs,
an inverter with a USB control and information interface,
connected vehicles.

Hereinafter, equipment using a local communications network means conventional equipment such as a personal computer, a smartphone or connected plugs, but also household appliances (heating, air-conditioning, etc.). This local communications network can also include energy production or storage sources that are alternatives to the electrical energy conventionally supplied by the mains, such as batteries internal to the home or business, or solar panels or wind turbines. In other words, a local communications network is a network comprising any equipment configured to connect to the gateway, which can then act on this equipment. Some of these devices can be connected remotely to the local network via a virtual private network. More generally, all the equipment in the local communications network managed by the gateway is referred to as a home or professional installation.

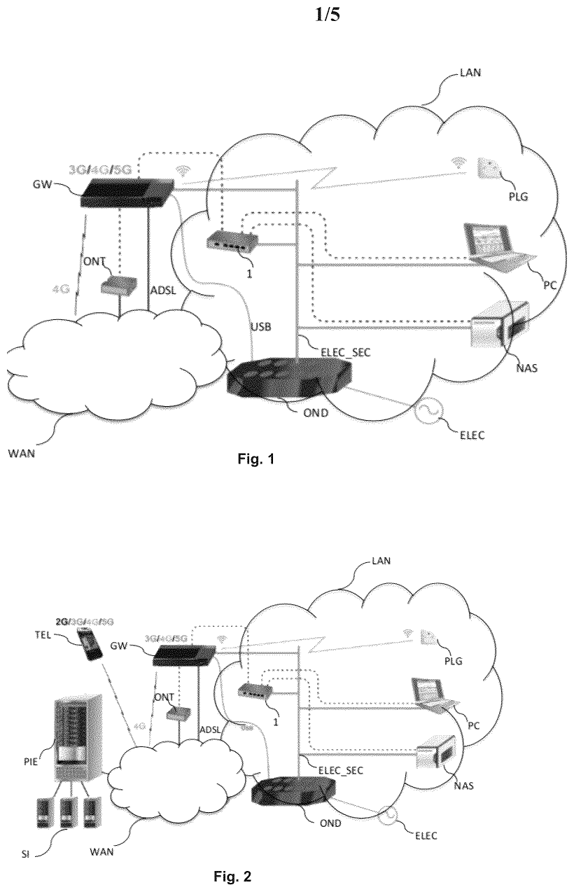

An example of an implementation environment of the development according to a particular embodiment of the development is now described in relation to FIG. 1. The environment illustrated in FIG. 1 particularly comprises a communications network LAN managed by a gateway GW for access to the remote network WAN. In the example considered, the gateway GW is connected to the remote network WAN via an ADSL or fibre link via an optical terminal box ONT. Naturally, it can also connect to the operator's cellular network via a 2G to 5G wireless radio link.

In this example, the LAN network is a home network, but such a communications network can also be found on industrial sites or very small businesses. This local communications network LAN comprises a number of devices connected to each other via the gateway, such as a connected plug PLG, a PC personal computer and a Network Attached Storage (NAS) server. These pieces of equipment are connected to the gateway GW. For example, the NAS storage server and the PC are connected to the gateway GW by a wired link, for example of the Ethernet type directly on the gateway or via a switch 1 itself connected to the gateway by a wired link of the Ethernet type. Other types of connection can be envisaged, such as USB or PLC over electrical wiring. The connected plug PLG is connected via a wireless radio link, for example Wi-Fi. Naturally, other types of wireless links can be used such as Bluetooth, Bluetooth Low Energy, z-wave, zigbee, DECT-ULE, etc.

The LAN communications network may also include other basic elements such as for example:
one or more pieces of home terminal equipment and connected objects (not shown),
an inverter OND supplied with electricity ELEC by the electrical network of an energy supplier and equipped with a USB control and information interface connected to the gateway GW. The inverter OND backs up the power supply by providing back-up power ELEC_SEC to the LAN communications network equipment in the event of a mains failure. This back-up power resource is temporary, the duration depending on the capacity of the battery of the inverter OND and the consumption of the LAN equipment, and more generally on the home or professional installation.

Thus, according to this embodiment in relation to FIG. 1, in the event of a power failure in the mains, the gateway GW receives, via its USB interface for example, a message from a piece of equipment in the LAN local communications network comprising a back-up battery configured to supply the equipment in the LAN local communications network, such as the inverter OND for example.

This message notably comprises:
a piece of information relating to a power supply source external to the LAN communications network, such as power from an electricity supplier,
a piece of information relating to a power supply source internal to the LAN communications network, such as the battery of the inverter OND.

More specifically, the piece of information relating to an external power supply source corresponds to a piece of information relating to a change of status of this source, such as an interruption to the installation's electrical supply or the restoration of the electrical current.

The piece of information relating to the internal power supply source corresponds, for example, to:
the level of electrical power supplied by the battery of the inverter OND such that: the level of charge and capacity of the battery of the inverter OND and
a time limit for the availability of a level of energy power such that the autonomy of the LAN communications network can be predicted as a function of the current energy power consumed by the home or professional installation.

The inverter OND and the gateway GW can communicate using a standard and well-known USB-type communication protocol. The messages exchanged are of the application type with a low-level proprietary protocol. For example, the gateway GW sends an OND query message of the type: “001” to determine the battery charge, the inverter OND can respond with a message for example “100%”. In another example, the gateway GW sends an OND query message of the type: “002” to determine the theoretical maximum capacity of the battery, the inverter OND may respond with a message for example “83%”.

Depending on the capacity and battery charge of the inverter OND and the autonomy time depending on the current needs of the equipment in the home or professional installation, the gateway GW transmits commands to this equipment to shut down or put on standby all or part of its components, interfaces, services and/or functions.

Alternatively, the gateway GW can also transmit a command to switch on alternative energy sources internal to the installation, such as back-up batteries of a piece of equipment, or independent batteries internal to the home or business that have been recharged beforehand.

In order to ensure an appropriate selection of equipment or internal hardware or software components of this equipment to be shut down, put on standby, maintained or put into service, the gateway GW takes into account situations, or use cases, which define equipment priority levels, and/or the power consumption level of the equipment.

In one example, a usage situation is a “holiday” situation. This usage situation therefore defines priority levels for communications network equipment in the event that the inhabitants of a home are on holiday. For example, the alarm control unit must remain powered (high priority level, e.g. 1), as must the gateway GW (high priority level, for example 1), but not necessarily the Wi-Fi interfaces (low priority level, for example 0) if other means of communication are available on the LAN communications network, while the fridges/freezers can withstand a power failure of a certain duration.

In another usage situation example known as “present during the day”: the gateway GW must remain powered with the 2.45 GHz Wi-Fi interface switched on (high priority level, e.g. 1), but not necessarily the alarm control unit (low priority level, e.g. 0) or the other 5 GHz or 6 GHz Wi-Fi interfaces (low priority level, e.g. 0), while the fridges/freezers can withstand a power failure of a certain duration.

In this way, equipment with a high priority is kept in service or even brought into service (in the case of back-up batteries, for example), while equipment with a low priority is put on standby or even shut down.

In one variant, the gateway also takes into account an individual level of equipment consumption in order to decide which equipment, or hardware or software components, need to be shut down, put on standby or put into service.

In another example, an item of low-priority equipment that consumes a lot of energy is switched off, whereas an item of high-priority equipment that consumes a lot of energy is put on standby, or even remains powered if it is important within the communications network (e.g. the gateway).

In the event of a mains failure, the inverter OND continues to supply the installation. The gateway GW then selects, according to the level of charge and capacity of the battery of the inverter OND and the foreseeable autonomy, the equipment or internal hardware or software components of this equipment:
to be put into service, such as, for example, any back-up batteries internal to the equipment or external or other alternative electrical resources internal to the installation,
to be totally or partially shut down or put on standby.

To do this, the gateway GW sends to the equipment in the installation commands for putting into service, planned outage or putting into standby all or part of the hardware or software components they support.

The inverter OND or the alternative power supplies commissioned by the gateway GW continue to send messages to the gateway GW about their remaining autonomy.

When it receives information about an imminent planned outage of the emergency power solutions (from the inverter OND or alternative power supplies), the gateway GW switches the entire installation to an ad hoc planned outage mode by sending a planned outage command to the equipment of the installation.

When the power supply ELEC is restored, the gateway GW may decide to put certain elements back into service, and notifies the equipment by message.

An example of an implementation environment of the development according to another particular embodiment of the development is now described in relation to FIG. 2. In this embodiment, the gateway GW receives information relating to an external power supply source from information systems IS of energy suppliers via a power supply information platform PIE, via the remote network WAN.

In this example, the management of the power consumption of the communications network LAN by the gateway therefore also involves the implementation of a service platform operated by the network operator to which the user has subscribed, called a power supply information platform, or PIE. This platform PIE then acts as an intermediary between the information systems, or IS, of the energy suppliers and the gateway, providing the latter with this information relating to a power supply from the suppliers. The gateway can then inform the user and, if necessary, modify the power supply source for the local communications network it manages and, more generally, for the home or professional installation.

For example, in the event of recommendations or orders emanating from the electricity network following foreseeable or present voltages (for example foreseeable thanks to meteorological data or linked to current meteorological conditions) in the local or regional electricity supply, the gateway then receives an alert message, for example from the platform PIE, comprising information relating to a voltage on the network.

The gateway can decide to use on the local communications network, or more generally in the installation, the home's internal batteries, which were previously recharged during off-peak hours, rather than the energy of the supplier, and/or switch the home or professional installation to “low consumption” mode by controlling the equipment connected to the LAN and by modifying or adapting its electricity consumption (for example by putting on standby the equipment totally or certain internal hardware or software components of the equipment partially).

This service offered by the platform PIE enables home or professional gateways to manage the power consumption of the local communications network, and of the home or professional installation in general, by providing information on:
the external supply source: level of power supplied by the electricity supplier,
the energy price or cost associated with the power level supplied by each supplier,
an availability timeframe (for example: constant supply price evolution information (kVA), constant unit or fixed price supply evolution information, price and supply evolution information), and
if applicable, forecasts of meteorological events affecting the availability of the electricity network or the consumption of local communications network equipment.

The platform PIE is responsible for managing, on behalf of each user who has subscribed to a power supply management service and is therefore registered with the platform PIE:
storing information about the user's contracts with energy suppliers,
storing the type of notifications desired by the user, including parameters relating to:
   the visibility horizon for current or planned changes in electrical load or pricing,
   the desired distribution channels: SMS, e-mail, etc.
   the Internet Protocol (IP) address and port of the gateway used to address these notifications in the form of an application message to an energy management application on the communications network it manages,
the active or passive collection from these suppliers of information on their current prices according to the power consumed and, where applicable, their forecast changes,
the active or passive collection from these suppliers of information on the power currently available to each of them and, where applicable, any planned changes,
storing and updating of the information collected,
making this information available to the user via a server,
sending notifications to the user:
   relating to changes in electrical load or pricing that are current or planned within the limits desired by them,
   via the channels desired by them,
   to the gateway in the form of an application message.

### Registering the Customer Account on the Energy Information Platform.

The platform PIE has the following information for each energy supplier partnering the service it supports:
energy supplier identifier,
access data to the IS of the energy supplier, to collect information,
access data from the IS of the energy supplier to the platform PIE, to receive notifications,
recording of the latest information received or collected:
   schedule of pricing changes according to contract class and location,
   schedule of changes in supply (power) according to contract class and location.

The platform PIE has the following information for each registered customer:
customer login to the service of the platform PIE,
customer access data to the service of the platform PIE,
addresses of its gateway(s) and/or equipment receiving notifications, with type of notification: e-mail, SMS, etc.
for each energy supplier partner of the platform PIE with which it has a contract for each of its installations:
   where applicable, the identifier of the customer with the supplier,
   where applicable, customer access data, from the supplier, for an embodiment where the platform PIE directly accesses the customer accounts of the distributors
   location of the installation,
   customer contract class for this installation,
   recording of the last notifications sent,
where applicable, the current energy supplier.

### Validation of the Energy Contracts of the User by the Energy Information Platform PIE.

The energy contracts of the user (suppliers, contract classes, etc.) are communicated by the user to the sales department responsible for managing the service of the energy information platform PIE. Where necessary, these energy contracts are validated by the sales department with energy suppliers before being entered into a database on the platform PIE.

This database of the PIE is ordered for each user installation according to the suppliers contracted, the contract classes specific to them, and any locations (and geographical granularity) specific to them. In particular, it contains the addresses, as well as the access data, of the gateway(s) of the user and/or the equipment receiving the notifications, such as the smartphone TEL, with the nature of the notifications (e.g. e-mail, SMS, etc.).

Periodically, the validity of this information is checked at the initiative of this sales department, which receives, where appropriate, information on these contracts from energy suppliers and/or users themselves.

In parallel, when the platform PIE detects an anomaly, it informs the sales department. In one example, an anomaly can be the power supply contract number indicated by the customer of the platform PIE that is no longer valid in the information system of the energy supplier concerned.

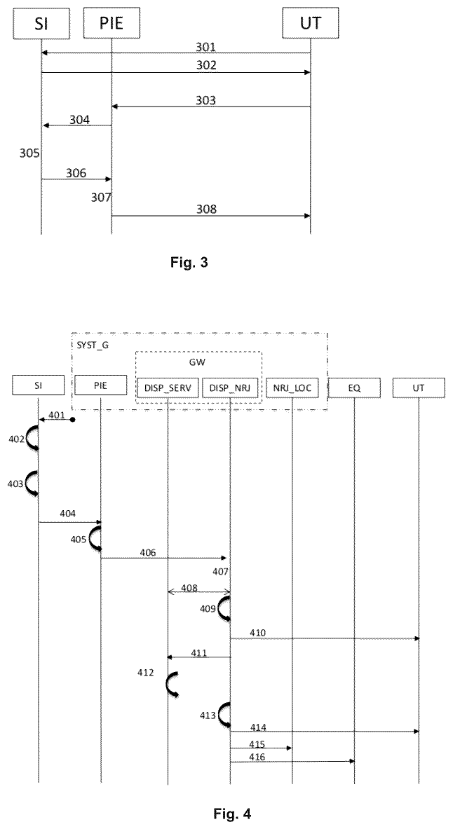

An example of a process for subscribing to the energy information service and validating customer information for a given customer/supplier relationship is now shown in FIG. 3.

In a step 301, the user UT makes a subscription request for a power supply contract with a given supplier. In return, in a step 302, the information system IS of the supplier to which the user UT has just subscribed sends the user UT confirmation of the subscription and the customer references of the user. In a step 303, the user also subscribes to the energy management service of the energy information platform PIE by providing the platform PIE with their customer references, their location and their customer references with an Internet access provider with, in particular, the address and access data for their home or professional gateway. In a step 304, the platform PIE transmits the customer references and the user's location to the IS of the supplier for verification of the customer data and assignment of a customer profile (step 305) and validation of these with the platform PIE (step 306). In step 307, the platform PIE then records the customer profile of the user and sends the user a subscription validation notification (step 308) by e-mail, for example.

Collecting Information from Energy Suppliers

Information from the energy supplier partners of the platform PIE service for the various contract classes and geographical locations can be obtained in “push” or “pull” mode, that is passively or actively, in the form of messages or files. These modes of communication can be used simultaneously, independently of suppliers.

Where appropriate, this information can be supplemented by information from the energy producers themselves, or even from the administrative authorities, which can be managed in the same way.

Contract classes may be defined differently from one energy supplier to another.

In one example, such an information message transmitted to the platform PIE by the information system IS of an energy supplier for a given geographical area with two pricing classes:

### Zone Zone 1:

Class class_1
   from now to date:time_1:
      Pmax P1 kVA
      from zero kWh to N1 kWh price P1 per kWh,
      from N1 kWh to N2 kWh price P2 per kWh,
      from N2 kWh to plus price P3 per kWh,
from date:time_1 to date:time_2:
   Pmax P2 kVA
   from zero kWh to N3 kWh price P1 per kW,
   from N3 kWh to plus price P4 per kWh,
from date:time_3 to plus:
   Pmax P1 kVA
   from zero kWh to N1 kWh price P1 per kWh,
   from N1 kWh to N2 kWh price P2 per kWh,
   from N2 kWh to plus price P3 per kWh,
Class class_2
from now to date:time_4:
   Pmax P1 kVA
   from zero kWh to N4 kWh price P5 per kWh,
   from N5 kWh to plus price P6 per kWh,
from date:time_4 to date:time_5:
   Pmax zero kVA (programmed supply interruption)
from date:time_5 to plus:
   Pmax P1 kVA
   from zero kWh to N4 kWh price P5 per kWh,
   from N5 kWh to plus price P6 per kWh,

### End_of_file

### Passive Collection

In this collection mode, the IS of energy suppliers transmit to the platform PIE application messages or authenticated files detailing their current situation or their schedules for changes in pricing or charges for their different classes of customer contracts and customer locations, or even for individual customers.

### Active Collection

In this other collection mode, the platform PIE connects at regular intervals to the IS of energy suppliers to download files detailing their current situation or their schedules for changes in pricing or charges for their different classes of customer contracts and customer locations.

In one variant, the PIE may also have to manage information for energy distributors who bill on a pay-as-you-go basis, without a subscription.

### Possible Collection of Other Types of Information.

In a particular mode of implementation, the platform PIE may also be able to collect, on behalf of its subscribers, from ad hoc suppliers, and using similar techniques, information relating, for example, to weather forecasts according to geographical areas, with a level of precision in terms of time and intensity sufficient to determine whether or not the equipment in the user's installation will need to activate heating or air-conditioning systems, for example.

Alternatively, such information can be obtained by the gateway via other channels, for example directly from the Internet.

### Storing Information on the Platform

Having collected information from energy suppliers, the platform PIE stores it in a database, ordered according to suppliers, the contract classes specific to them, and any locations (and geographical granularity) specific to them.

### Provision of Power Supply Information for the User

The platform PIE has a file server which stores in memory, for each user's installation, a file of the latest dated information still valid relating to its power supply.

When a gateway, or another piece of customer equipment, such as the smartphone TEL, connects to the platform PIE and then advantageously identifies and authenticates itself, the platform PIE proceeds as follows:
The gateway (or another piece of equipment) identified is associated with a user and an energy installation for that customer. The platform PIE is designed for customers of one or more Internet service providers. Users are therefore identified either by their account with their access provider, or by an account with the service managing the platform PIE and specific to such service. For security and personal data protection reasons, it does not seem advisable to use the identifier of an account with an energy supplier for access purposes. In addition, in one example, the user of the platform PIE can of course obtain general information, for example selected by choosing a given geographical area.
The platform PIE searches for distribution contracts relating to this installation,
The platform PIE searches for the location of this facility according to the distribution contracts,
The platform PIE searches for any new supplier information for these types of contract and this location,
If necessary, the platform PIE updates the information file for this installation,
The platform PIE makes this file available to the customer.
The search by the platform PIE for any new supplier information based on contract types and locations for updating information files can advantageously be carried out in the background, particularly for deleting out-of-date information.
Once the energy information file has been made available to the user, then it is possible for the gateway, or user equipment such as the smartphone TEL, to download it.
The gateway GW has an interactive web server. When an identified and authenticated user connects to the platform PIE:
the platform PIE offers them a choice of all or some of its installations,
the platform PIE presents the information about its installations to them, which it has stored in a file for each one, and offers them to download it.

### Information Sent to the User.

Periodically, for example once a day, or just in the event of an update, the platform PIE can send the user the energy information files that concern them, concatenated into a single file or separated.

The choice of concatenation and means of transmission of this information by the platform PIE depends on the user parameters for its various installations, stored in one of the databases of the platform PIE.

Depending on these parameters, the platform PIE can edit an application message containing the energy information file for each installation and send it to the gateway GW concerned using an ad hoc application protocol known in the state of the art, or download these files directly to the gateway GW using a standard file transfer protocol.

In one variant, depending on these parameters, the platform PIE can edit an application message containing the energy information file(s) for its installations and send it to the user in the text form (enhanced for improved readability) of an e-mail or SMS, or in the form of a file attached to an e-mail, or in graphic form in an MMS.

### Information Received by the Gateway

The energy information intended for the gateway GW of a given customer installation can be obtained in “push” or “pull” mode, that is passively or actively.

### Active Collection

In this active collection mode, the gateway GW connects to the PIE at regular intervals, for example every day, to download, after identifying and authenticating itself, the file detailing the current status or schedules of pricing or load changes for the home or business installation.

### Passive Collection: Receiving an Application Message

In this other collection mode, referred to as passive, the gateway GW receives by download, or within an authenticated application message, a file detailing the current status or timetable of pricing or load changes of its installation.

In an example of the content of such a file, presented here in readable form, with, for a same user, a first installation with a first supplier informing of a temporary change in pricing, and a second installation with a second supplier informing of a temporary interruption in supply:

Customer customer_1
Installation installation_1
Supplier supplier_1:
   from now to date:time_1:
      Pmax P1 kVA
      from zero kWh to N1 kWh price P1 per kWh,
      from N1 kWh to N2 kWh price P2 per kWh,
      from N2 kWh to plus price P3 per kWh,
   from date:time_1 to date:time_2:
      Pmax P2 kVA
      from zero kWh to N3 kWh price P1 per kW,
      from N3 kWh to plus price P4 per kWh,
   from date:time_3 to plus:
      Pmax P1 kVA
      from zero kWh to N1 kWh price P1 per kWh,
      from N1 kWh to N2 kWh price P2 per kWh,
      from N2 kWh to plus price P3 per kWh,
         Installation installation_2
Supplier supplier_2:
   from now to date:time_4:
      Pmax P1 kVA
      from zero kWh to N4 kWh price P5 per kWh,
      from N5 kWh to plus price P6 per kWh,
   from date:time_4 to date:time_5:
      Pmax zero kVA (programmed supply interruption)
   from date:time_5 to plus:
      Pmax P1 kVA
      from zero kWh to N4 kWh price P5 per kWh,
      from N5 kWh to plus price P6 per kWh,

### End_of_file

When a consumption ceiling is set by contract, or the supply is interrupted, the price can be considered to be infinite above the threshold.

### Storing Information on the Gateway

Once it has this file, the gateway GW stores its contents in a database in order to;
make it available to the user for consultation on their internal web server,
exploit the content:
   manage the electricity consumption of the facility's equipment, including its own resources,
   where appropriate, guide the choice of another energy supplier or an alternative source, possibly a local private one.

### Information Processed by the Gateway

The gateway GW, or another equivalent item of equipment, also has the following information:
A schedule of usage situations managed by the gateway orchestrator (or service management device), comprising, for example, equipment priority levels according to usage situations (a high priority is defined, for example, by an integer 1 and a low priority by an integer 0). High-priority equipment must remain switched on, while low-priority equipment can be shut down or put on standby. This schedule also makes it possible to determine, for example, the energy requirements of a piece of equipment in a situation where the equipment is fully or partially put into service, and whether or not this equipment can be powered by a local alternative energy resource, such as an internal battery or a private energy source (e.g. solar panels);
A schedule of internal consumption and resources comprising:
   Information on the overall electricity consumption of the home or professional installation, including standard LAN equipment, the heating/air-conditioning system and household appliances, as well as the individual consumption of each piece of equipment;
   an updated and foreseeable statement of the capacity of any internal energy sources specific to the installation, such as a wind turbine, a tidal turbine, solar panels, a generator, batteries, etc.;
   This schedule is managed by the gateway GW. It can be explicitly filled in beforehand by the user of the gateway GW or be deduced by the gateway for example from a schedule of programmed or previously determined usage situations (use of Artificial Intelligence, or AI, to build a prediction model capable of providing output information relating to the power consumption of the installation in a usage situation on the basis of input information on this usage situation);
where appropriate, decision criteria such as:
   a maximum cost threshold acceptable to the user associated with a level of power supplied by the suppliers, from which the user can choose dynamically to a certain extent (to avoid any speculative peaks) the one that supplies one or more of their installations, either directly or through a broker,
   a priority level and/or an individual power consumption level for local network equipment.

Where applicable, an internal schedule for choosing the energy supplier for the installation, explicitly defined by the customer or estimated by an IA internal to the gateway GW or hosted by an external service logic, based on information received from the various suppliers.

According to this particular embodiment, the gateway GW is configured to trigger the implementation of the proposed consumption management process periodically or on receipt of new information from the platform PIE or a piece of equipment of the LAN. For example, it receives information about an external source of supply from the platform PIE. On the other hand, information relating to an internal source of supply and information relating to the level of consumption of local communications network equipment is obtained from the consumption schedule and internal resources. By taking this information into account, along with other information obtained from the usage situation schedule (for example, equipment priority level) and the energy supplier selection schedule, it is possible to select suppliers, and therefore energy prices, based on the current or forecast overall consumption of the equipment of the LAN, local private energy resources (presumed to be free) and one or more of the decision criteria mentioned above, such as the maximum acceptable energy cost threshold, for example defined by the user.

Advantageously, when a maximum acceptable cost threshold has been previously determined, the gateway calculates any periods of time when the maximum acceptable cost threshold is likely to be exceeded.

This means that if power consumption exceeds a certain level, the gateway can reduce the period of excess consumption and avoid a high electricity bill. Depending on the situation or use case, the gateway can implement a strategy to avoid exceeding the limit by switching to the consumption of local private non-renewable energy (e.g. internal batteries of the equipment or of the home), or by directly modifying the consumption of the equipment by temporarily shutting down the equipment or some of its hardware and/or software components, or by putting them into total or partial standby mode.

If such potential overruns exist, the gateway GW sends a notification (SMS alert, e-mail, etc.) to the user and makes the overrun schedule available on its web server. At the same time, the gateway GW can implement a strategy based on the following functionalities:
where applicable, determining a schedule for the management by the gateway GW or controlled by it of local private non-renewable energy sources (generator, batteries, etc.), to reduce these periods of overrun,
development of a schedule for the management by the gateway GW or controlled by it of home equipment, with:
   temporary programmed interruption of the power supply to certain equipment, either by sending ad hoc application messages to them or to the programmed plugs which supply them,
   temporary standby of certain energy-consuming resources of this equipment, including the gateway GW.

The implementation of this strategy by the gateway GW is advantageously updated in real time by the latter according to the information provided by the platform PIE and any measurement of current consumption.

A flow diagram illustrating an example of the sequencing of actions for managing the power consumption of a local communications network in a power supply management system according to a particular embodiment is shown in relation to FIG. 4.

In a step 401, the information system IS of the energy supplier receives, for example via the Internet, data on predicted weather events or industrial events.

In one example, an energy producer informs a supplier/distributor that:
the nuclear power plant it manages is shut down due to drought, flooding or non-compliance,
a hydraulic power station has to be shut down for repairs following an alternator explosion,
that a trawler has torn the underwater power cable away from an entire offshore wind farm,
and that its production capacity for this supplier will fall as a result.

The IS of the energy supplier updates its schedule of consumption and available energy resources to adapt its consumption strategy and the resources to be used, and selects customer profiles and locations that are impacted by these meteorological or industrial events (step 402).

In step 403, the IS of the energy supplier triggers the implementation of the strategy defined above. To do this, the IS of the energy supplier sends a notification including the customer profile, location and energy information from its consumption and resource schedule to the platform PIE, which then identifies the user associated with the customer profile and its location (step 405).

In a step 406, the platform PIE sends a notification to the gateway GW, and in particular to its energy management device DISP_NRJ comprising the energy information from the IS of the supplier.

The energy management device DISP_NRJ then creates a power consumption and resource management schedule (steps 407) for the installation, which describes in particular the current status of consumption of the installation, as well as the forecasts in this respect, whether they are defined by the user UT, or by analysis of their value in past situations, or use cases.

The energy management device DISP_NRJ sends the power supply services management device DISP_SERV a request to obtain the schedule of situations, or use cases, specific to the installation of the user concerned (step 408). Then, in a step 409, the energy device DISP_NRJ creates a schedule of action sequences to be executed by selecting these action sequences according to the consumption and resource schedule and the use case schedule, and updates its action schedule. In a step 410, the energy device DISP_NRJ sends a notification to the user UT, for example on their smartphone TEL, to inform them of the actions implemented in response to the energy information from the IS of the energy supplier.

In a step 411, the energy device DISP_NRJ sends a request to update the schedule of situations or use cases to the service management device DISP_SERV, which updates its schedule in response (step 412).

In a step 413, the energy device DISP_NRJ triggers the actions, notifying the user (step 414). These actions are, for example, the transmission of a command to activate alternative energy sources NRJ_LOC (step 415) (for example internal batteries in the house, private external power supply, etc.), the transmission of commands for planned outage, putting the equipment EQ into total or partial standby in the local communications network (step 416) or a command for reactivating a piece of equipment.

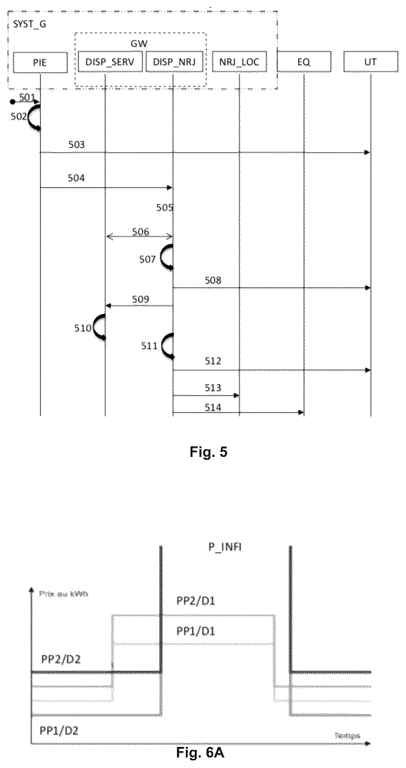

A flow diagram illustrating an example of the sequencing of actions for managing the power consumption of a local communications network in a power supply management system according to a particular embodiment is shown in relation to FIG. 5.

In this example, the gateway GW receives a notification from the platform PIE, relaying, for example, a forecast of an extreme weather or climate event, or an injunction from a local or national authority, with a global or local scope. The sequencing for the actions is similar to the example presented in relation to FIG. 4.

In step 501, the platform PIE receives external data on weather events, for example via Internet. The platform PIE handles the formatting of this external data and identifies a user by location (step 502).

In a step 503, the platform PIE sends a notification to the user comprising the formatted external data.

In parallel, the platform PIE also transmits this external data to the energy management device DISP_NRJ of the gateway GW (step 504).

The energy management device DISP_NRJ has a power consumption and resource management schedule (505) in memory, which describes their current status, as well as the forecasts in this respect, whether they are defined by the user UT, or by analysis of their value in past situations, or use cases.

The energy management device DISP_NRJ sends the power supply services management device DISP_SERV a request to obtain the schedule of situations, or use cases, specific to the installation of the user concerned (step 506). Then, in a step 507, the energy device DISP_NRJ selects sequences of actions to execute and updates its schedule of actions. In a step 508, the energy device DISP_NRJ sends a notification to the user UT, for example on their smartphone TEL, to inform them of the actions implemented in response to the energy information from the IS of the energy supplier.

In a step 509, the energy device DISP_NRJ sends a request to update the schedule of situations or use cases to the service management device DISP_SERV, which updates its schedule in response (step 510).

In a step 511, the energy device DISP_NRJ triggers the actions, notifying the user (step 512). These actions are, for example, the transmission of commands to activate alternative energy sources NRJ_LOC (step 513) (for example internal batteries in the house, private external power supply, etc.), of commands for planned outage, putting the equipment EQ into total, partial standby or reactivation in the local communications network (step 514).

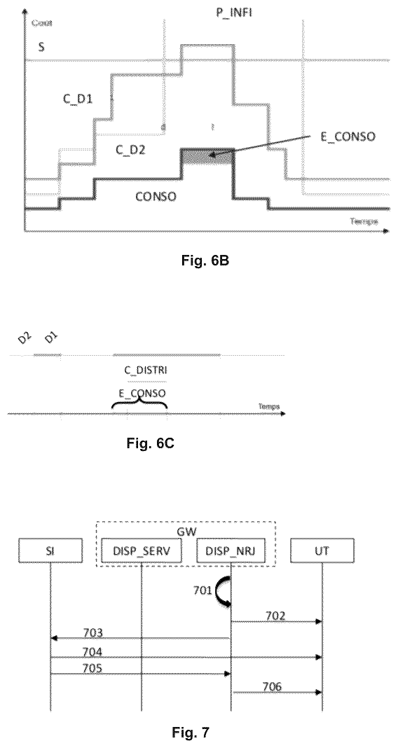

A graph illustrating an example of changes over time in the pricing levels of two energy suppliers is now shown in relation to FIG. 6A.

For the two energy suppliers D1 and D2, the prices charged change over time. For example, the first supplier has two pricing levels PP1/D1 and PP2/D1, and the second supplier has two pricing levels PP1/D2 and PP2/D2. In the event of a supply interruption, the second supplier D2 charges an infinite price P_INFI. In other words, when a consumption ceiling is set by contract, or the supply is interrupted, the price can be considered to be infinite above the pricing level applied.

FIG. 6B graphically shows an example of the costs compared according to the supplier, with the power consumption changing over time, with evidence of excess consumption by exceeding the maximum desired cost.

As previously mentioned in relation to FIG. 6A, the various energy suppliers D1 and D2 apply pricing C_D1 and C_D2 which change over time, for example in the middle of the day prices may rise as electricity consumption increases. Thanks to its power supply management service, the user can set a cost threshold S that must not be exceeded. Over time, the estimated consumption CONSO of the installation of the user can vary, and sometimes an excess of consumption E_CONSO can be detected, for example in the middle of the day.

An example of the costs compared according to the supplier, with evidence of excess consumption by exceeding the maximum desired cost is now shown in relation to FIG. 6C.

After comparing the costs C_D1 and C_D2 according to the suppliers D1 and D2 according to the current consumption and estimated consumption CONSO, the gateway GW is able to propose and/or implement a reduction scenario for sequencing the choice of supplier and voluntarily reducing power consumption, with the possibility of proceeding by successive approximations. Detecting this possibility of a period of over-consumption, the gateway GW may, for example, decide to proceed for the duration of this period with a measure to reduce power consumption on the LAN and/or to implement alternative means of power supply, as for example local private resources, such as batteries, whose full load it therefore plans in advance.

A graph illustrating an example of sequencing for the direct selection or deselection by the gateway GW of an energy supplier for a limited or unlimited period of time (thus presumed to be unlimited) is now shown in relation to FIG. 7.

To make life easier for the user, the gateway GW can advantageously select the energy supplier itself over time, by sending ad hoc application messages to the client interface of the IS front-end of the selected or deselected energy supplier.

To do this, in a step 701, the energy management device DISP_NRJ of the gateway GW selects sequences of actions to be implemented to limit, for example, the power consumption of the LAN, and also chooses to select/deselect an energy supplier to limit costs. For example, these actions are the transmission of a command to bring another power supply source into service, such as changing a supplier, or a command for planned outage of a current power supply source, such as deselecting a current electricity supplier.

In a step 702, the energy management device DISP_NRJ sends a notification to the user informing them of their choices of action and selection/deselection of energy suppliers. At the same time, in a step 703, the energy management device DISP_NRJ, via the service management device DISP_SERV of the gateway GW, sends a selection/deselection message to the suppliers concerned. This message includes the customer's references and the date and time when the energy contract with the suppliers concerned takes effect.

In a step 704, the IS of the energy supplier sends a notification to the user UT informing them of their selection or deselection with the start or end date of the contract.

In a step 705, the selected/deselected energy supplier sends a notification to the energy management device DISP_NRJ, via the service management device DISP_SERV of the gateway GW, of validation of the selection or deselection.

In a step 706, the energy management device DISP_NRJ also notifies the user of the selection/deselection of an energy supplier.

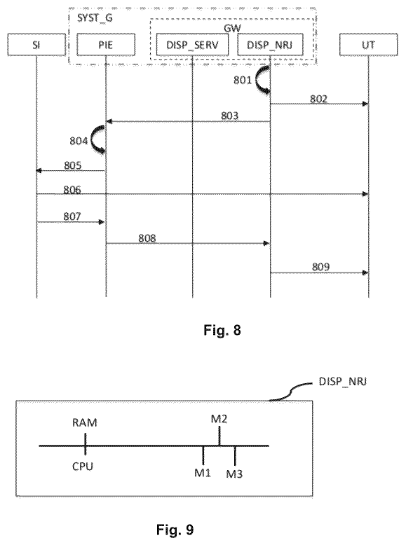

A graph illustrating an example of sequencing for the direct selection or deselection by the platform PIE of an energy supplier for a limited or unlimited period of time (thus presumed to be unlimited) is now shown in relation to FIG. 8.

In this embodiment, the transmission of the ad hoc application message to the front-end customer interface of the IS of the selected or deselected energy supplier can advantageously be carried out via the PIE, because the gateway GW and the IS of the various energy suppliers do not necessarily know each other, whereas these IS and the platform PIE know each other.

In a step 801, the energy management device DISP_NRJ of the gateway GW selects sequences of actions to be implemented to limit, for example, the power consumption of the LAN, and also chooses to select/deselect an energy supplier to limit costs.

In a step 802, the energy management device DISP_NRJ sends a notification to the user informing them of their choices of action and selection/deselection of energy suppliers. At the same time, in a step 803, the energy management device DISP_NRJ, via the service management device DISP_SERV of the gateway GW, sends a relevant supplier selection/deselection message to the PIE.

In step 804, the platform PIE then selects the IS of the suppliers concerned by this selection/deselection, and sends a selection/deselection message to the suppliers concerned (step 805). This message includes the customer's references and the date and time when the energy contract with the suppliers concerned takes effect.

In a step 806, the IS of the energy supplier sends a notification to the user UT informing them of their selection or deselection with the start or end date of the contract. In parallel, the IS of the supplier concerned sends a message validating the selection/deselection operation to the platform PIE (step 807).

In a step 808, the platform PIE sends a notification to the energy management device DISP_NRJ, via the service management device DISP_SERV of the gateway GW, of validation of the selection or deselection.

In a step 809, the energy management device DISP_NRJ also notifies the user of the selection/deselection of an energy supplier.

In one variant, in addition to the above, a supplier selection/deselection smoothing function can be implemented by the platform PIE, which then acts as a broker or partner of a broker.

This method has the advantage of avoiding mass selection/deselection phenomena, which could destabilise the energy market if such a service offer were to be extended to too many customers, particularly large customers, and with too little temporal or financial granularity.

In order to illustrate the principle of the development more precisely, FIG. 9 diagrammatically shows an example of the architecture of a device for managing the energy resources made available to the equipment of the communications network according to a particular embodiment.

The energy resource management device DISP_NRJ comprises a random access memory (a RAM memory, for example), a processing unit equipped for example with a processor and controlled by a computer program stored in a read-only memory (a ROM memory or hard disk, for example). At initialisation, the code instructions of the computer program are for example loaded into the random access memory RAM before being executed by the processor of the processing unit CPU.

The energy resource management device DISP_NRJ further comprises:
a module M1 for obtaining at least one piece of information relating to a power supply source, this source being able to be internal and/or external to the local communications network LAN;
a module M2 for obtaining at least one piece of information relating to a power consumption level of the equipment of the local communications network (LAN);
a module M3 for controlling modification of the consumption level of the equipment and/or the power supply source according to the information obtained by modules M2 and M3.

In particular, the modification command module M3 is configured to implement actions such as the transmission of at least one modification command selected from:
a command for planned outage of a piece of equipment according to the priority level and/or the individual consumption level of this piece of equipment;
a command for putting a piece of equipment into standby according to the priority level and/or the individual consumption level of this piece of equipment
a command for reactivating a piece of equipment,
a command for putting into service another internal and/or external power supply source (for example selecting/deselecting an energy supplier, activating a back-up battery, etc.);
a command for planned outage of the power source, for example deselecting a current supplier, or shutting down the use of a back-up battery.

In order to determine which commands must be transmitted, the command module M3 takes into account at least one decision criterion from the group comprising:
a cost threshold associated with an energy power level supplied by an external power supply source;
a priority level and/or an individual power consumption level for the equipment of the local communications network (LAN).

In one variant, the planned outage, standby or reactivation command is intended for a particular hardware or software component of a piece of equipment, such as for example a 2.4 GHz WiFi interface.

FIG. 9 only shows a particular one of several possible ways of realising the energy resource management device DISP_NRJ, so that it executes the steps of the energy resource management method as detailed above, in relation to FIGS. 2, 4, 5, 7 and 8 in its various embodiments. Indeed, these steps may be implemented indifferently on a reprogrammable computing machine (a PC computer, a DSP processor or a microcontroller) executing a program comprising a sequence of instructions, or on a dedicated computing machine (for example a set of logic gates such as an FPGA or an ASIC, or any other hardware module).

In the case where the energy resource management device DISP_NRJ is realised with a reprogrammable computing machine, the corresponding program (that is the sequence of instructions) can be stored in a removable (such as, for example, an SD card, a USB flash drive, CD-ROM or DVD-ROM) or non-removable storage medium, this storage medium being partially or totally readable by a computer or a processor.

1. A method of managing the power consumption of a local communications network to which at least one piece of user equipment is connected, the local communications network being managed by a gateway for access to a remote communications network, wherein the method is implemented by the gateway and comprises:
obtaining at least one piece of information relating to at least one power supply source for the local communications network;
obtaining at least one piece of information relating to a power consumption level of the at least one piece of equipment; and
a command for modifying the power consumption level of the at least one piece of equipment and/or the at least one power supply source according to the information obtained, the modification command depending on a priority level and/or an individual power consumption level of the at least one piece of equipment.

2. The method of managing power consumption according to claim 1, wherein the modification command further depends on a cost threshold associated with an energy power level supplied by at least one power supply source external to the local communications network.

3. The method of managing power consumption according to claim 1, wherein the command for modifying the power consumption level of the at least one piece of equipment is selected from:
a command for shutting down the at least one piece of equipment according to the priority level and/or the individual consumption level of the at least one piece of equipment;
a command for putting the at least one piece of equipment on standby according to the priority level and/or the individual consumption level of the at least one piece of equipment; and
a command for reactivating the at least one piece of equipment.

4. The method of managing power consumption according to claim 1, wherein the command for modifying the at least one power supply source is selected from:
a command for putting into service another power supply source; and
a command for planned outage of the at least one power supply source.

5. The method of managing power consumption according to claim 2, wherein the at least one piece of information relating to the at least one power supply source belongs to a group comprising:
a piece of information relating to the energy power level supplied by the at least one power supply source;
a piece of information relating to a time limit for the availability of the energy power level supplied by the at least one power supply source;
a piece of information relating to a cost associated with the energy power level supplied by the at least one external power supply source; and
a piece of information relating to a supply incident involving the external energy source.

6. The method of managing power consumption according to claim 5, wherein the at least one piece of information relating to the at least one power supply source is obtained from a message received from an information platform relating to a power supply via the remote communications network.

7. The method of managing power consumption according to claim 5, wherein the at least one piece of information relating to the at least one power supply source is obtained from a message received from a piece of equipment of the local communications network comprising an internal power supply source configured to supply the at least one piece of equipment of the local communications network.

8. Computer A processing circuit comprising a processor and a memory, the memory storing program code instructions of a computer program for implementing the method for managing a power consumption according to claim 1, when the computer program is executed by the processor.

9. A device for managing a power consumption of a local communications network to which at least one piece of equipment is connected, the said local communications network being managed by a gateway for access to a remote communications network, wherein the management device comprises:
a first module for obtaining at least one piece of information relating to at least one power supply source for the local communications network;
a second module for obtaining at least one piece of information relating to a power consumption level of the at least one piece of equipment; and
a command module for modifying the power consumption level of the at least one piece of equipment and/or the at least one power supply source according to the information obtained, the command module being configured to take into account a priority level and/or an individual power consumption level of the at least one piece of equipment.

10. The management device according to claim 9, wherein the command module is further configured to take into account a cost threshold associated with an energy power level supplied by at least one power supply source external to the local network.

11. The management device of claim 9, wherein the command module is further configured to transmit a command to modify the power consumption level of the at least one piece of equipment selected from:
a command for shutting down the at least one piece of equipment according to the priority level and/or the individual consumption level of the at least one piece of equipment;
a command for putting the at least one piece of equipment on standby according to the priority level and/or the individual consumption level of the at least one piece of equipment; and
a command for reactivating the at least one piece of equipment.

12. The management device according to claim 9, wherein the command module is further configured to transmit a command to modify the at least one power supply source selected from:
a command for putting into service another power supply source; and
a command for planned outage of the power supply source.

13. A gateway of a local communications network configured to manage the local communications network to which at least one piece of equipment is connected, the gateway comprising a device for managing power consumption according to claim 9.

14. A system for managing the power consumption of a local communications network to which at least one piece of equipment is connected, the local communications network being managed by a gateway for access to a remote communications network, wherein the system comprises a gateway according to claim 13 and an information platform relating to a power supply connected to at least one information system of an energy supplier and configured to transmit to the gateway a message comprising at least one piece of information relating to at least one power supply source external to the local communications network.

15. A management system according to claim 14, wherein the management system further comprises at least one piece of equipment of the local communication network comprising an internal power supply configured to power the at least one piece of equipment of the local communication network.
